(19) United States
(12) Patent Application Publication
(10) Pub. No.: US 2006/0105726 A1
(43) Pub. Date: May 18, 2006

(54) Leakage electromagnetic wave communication device

(76) Inventor: Tateo Masaki, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/992,272

(22) Filed: Nov. 18, 2004

(51) Int. Cl. H04B 1/18

(52) U.S. Cl. 455/179.1

(57) ABSTRACT

Reception channel information is communicated to the communication target with a communication device having a receiving function. A local oscillation frequency signal of a local oscillator is modulated with a digital modulator into frequency data as reception channel information, a local oscillation frequency signal associated with the oscillation operation of the local oscillator is leaked, the leaked leakage electromagnetic wave is transmitted to a receiver of the communication target disposed at a close distance, and the reception channel information is received with the receiver of the communication target.

### BACKGROUND OF THE INVENTION

1. Technical Field of the Invention

The present invention pertains to a leakage electromagnetic wave communication device constituted to communicate with a communication target by adding information to a leakage electromagnetic wave that leaks pursuant to the oscillation of a high frequency signal.

2. Description of the Related Art

As a digital broadcast receiver among receivers adopting the heterodyne detection method, a receiver of known type includes an antenna, a tuner, a demultiplexer, a decoder, a control unit (CPU), a memory, and so on (see, for example, pages 5 to 7 and FIG. 1 of Japanese Patent Laid-Open Publication No. 2003-152578).

With a receiver comprising a CPU, a keyboard as the input means is used to input frequency data relating to a plurality of reception channels, or frequency data relating to the reception channel is input with wired data communication via a dedicated wire communication interface circuit, and the input data is programmed with the processing of the CPU, and the programmed frequency data can be written in the memory as a result thereof.

Nevertheless, when there are numerous reception channels to be programmed, or when there are numerous receivers to be programmed, the operation for writing the frequency data as reception channel information becomes troublesome.

Thus, a proposal has been made to employ a method which uses a wireless data transmitter to transmit frequency data for programming frequency data, and to simultaneously transmit frequency data using a radio wave referred to as Over-The-Air-Programming from this wireless data transmitter to a plurality of receivers.

### SUMMARY OF THE INVENTION

In the conventional technology described above, it is necessary to prepare a dedicated wireless data transmitter for transmitting frequency data to a plurality of receivers, and there is a problem in that this is inconvenient.

The present invention resolves this problem by communication of reception channel information to a communication target with a communication device having a receiving function.

The present invention in one aspect relates to a leakage electromagnetic wave communication method, including the steps of: setting the reception frequency of one communication device among a plurality of communication devices to a designated frequency; setting the reception frequency of the other communication device to a local oscillation frequency of the one communication device; modulating the local oscillation frequency signal of the one communication device in accordance with reception channel information; and transmitting the local frequency signal modulated with the reception channel information as a leakage electromagnetic wave from the one communication device to the other communication device.

By such communication method, reception channel information can be transmitted to the communication device of the communication target by modulating the oscillation signal (local oscillation frequency signal) of one communication device in accordance with reception channel information, leaking the modulated signal from the communication device pursuant to the oscillation operation, and transmitting the leaked signal (local frequency signal) as a leaked radio wave to the other communication device. Thus, without having to provide a new wireless data transmitter or dedicated transmission circuit, reception channel information can be transmitted from one communication device having a receiving function to the other communication device of the communication target.

In the foregoing leakage electromagnetic wave communication method, a reception channel sound signal may be employed as the reception channel information.

In another aspect, the present invention relates to a leakage electromagnetic wave communication device, including: a high frequency amplifying means for amplifying a high frequency signal received with an antenna; a frequency oscillating means for oscillating the high frequency signal and a signal having a fixed frequency difference; a frequency mixing means for mixing the output signal of the high frequency amplifying means and the output signal of the frequency oscillating means and outputting an intermediate frequency signal; a processing means for setting an oscillation frequency of the frequency oscillating means; and a modulating means for modulating the oscillation signal of the frequency oscillating means in accordance with reception channel information.

Such leakage electromagnetic wave communication device may also include any of the following features:
(1) an intermediate frequency amplifying means for amplifying the intermediate frequency signal, and a demodulating means for demodulating the output signal of the intermediate frequency amplifying means and outputting data, wherein the processing means has a function of processing the data demodulated with the demodulating means and setting the oscillation frequency of the frequency oscillating means based on the processing result;
(2) the high frequency amplifying means having a function of receiving a radio wave belonging to one frequency band among the plurality of frequency bands and amplifying the high frequency signal from the received radio wave; and
(3) the frequency oscillating means having a function of oscillating the high frequency signal and the local oscillation frequency signal having a fixed frequency difference.

The device and method of the invention enable reception channel information to be transmitted to the communication device of the communication target by modulating the oscillation signal (local oscillation frequency signal) of the local oscillation means in accordance with reception channel information, leaking the modulated signal from the transmitter, and transmitting the leaked signal (local frequency signal) as a leaked radio wave to the transmitter of the communication target. Thus, without having to provide a new wireless data transmitter or dedicated transmission circuit, reception channel information can be transmitted from a transmitter having a receiving function to the transmitter of the communication target.

Other aspects, features and advantages of the invention will be more fully apparent from the ensuing disclosure and appended claims.

### BRIEF DESCRIPTION OF THE DRAWINGS

FIG. 1 is a block structure diagram of an illustrative embodiment of the leakage electromagnetic wave communication device of the present invention; and

FIG. 2 is a block structure diagram of the relevant portions for illustrating an embodiment of the leakage electromagnetic wave communication device having a plurality of frequency mixers and local oscillators and intermediate frequency amplifiers.

### DETAILED DESCRIPTION OF THE PREFERRED EMBODIMENTS

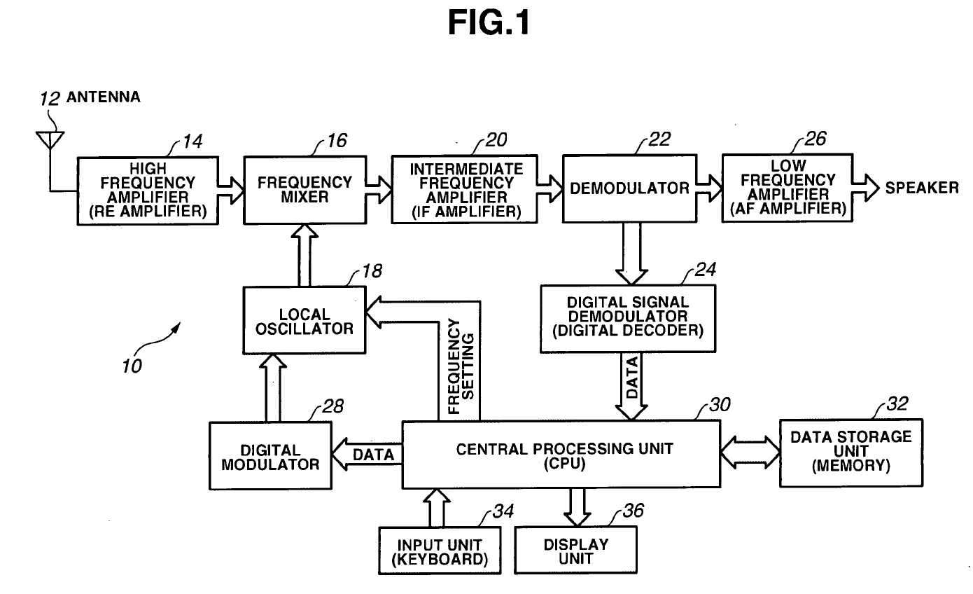

Embodiments of the present invention are now explained with reference to the drawings. FIG. 1 is a block structure diagram of the leakage electromagnetic wave communication device illustrating an embodiment of the present invention. In FIG. 1, the leakage electromagnetic wave communication device 10 is constituted as including, as a receiver adopting the heterodyne detection method, an antenna 12, a high frequency amplifier 14, a frequency mixer 16, a local oscillator 18, an intermediate frequency amplifier 20, a demodulator 22, a digital signal demodulator 24, a low frequency amplifier 26, a digital demodulator 28, a central processing unit (CPU) 30, a data storage device (memory) 32, an input unit (keyboard) 34, and a display unit 36.

The antenna 12 is constituted to receive a radio wave belonging to one frequency band among the plurality of frequency bands, and output the received radio wave to the high frequency amplifier 14. The high frequency amplifier 14 is constituted as a high frequency amplifying means for selecting a designated reception channel among the received radio waves of the antenna 12, amplifying the high frequency signal of the selected reception channel, and outputting the amplified high frequency signal to the frequency mixer 16.

The local oscillator 18 is constituted as a frequency oscillating means for outputting a high frequency signal output from the high frequency amplifier 14 and a local oscillation frequency signal as a signal having a fixed frequency difference, and, when the high frequency amplifier 14 receives a signal of 1300 MHz, for instance, it oscillates a signal of 919.3 MHz as the local oscillation frequency. The frequency mixer 16 is constituted as a frequency mixing means for mixing the high frequency signal and local oscillation frequency, and outputting the intermediate frequency signal to the intermediate frequency amplifier 20. For example, the frequency mixer 16 is constituted to mix a high frequency signal of 1300 MHz and a local oscillation frequency of 919.3 MHz, and output an intermediate frequency signal of 380.7 MHz. The intermediate frequency amplifier 20 is constituted as an intermediate frequency amplifying means for amplifying the intermediate frequency signal and outputting the amplified signal to the demodulator 22. The demodulator 22 is constituted to FM/AM-detect the intermediate frequency signal, output the detection output as a low frequency signal to the low frequency amplifier 26, and output the demodulated output to the digital signal demodulator 24. The low frequency amplifier 26 is constituted as a low frequency amplifying means for amplifying the low frequency signal and outputting the amplified signal to a speaker. The speaker is constituted to output sounds in accordance with the demodulated low frequency signal.

The digital signal demodulator 24 is constituted as a demodulating means for demodulating the demodulated output of the demodulator 22 as digital data, and outputting the demodulated digital data to the central processing unit 30. The central processing unit 30 is constituted to be input with the digital data demodulated with the digital signal demodulator 24 and the data associated with the operation of the operator from the input unit 34. The central processing unit 30 performs operation processing to the input data and displays the processing result on the screen of the display unit 36, as well as storing data relating to the processing result in the data storage device 32. Further, the central processing unit 30 sets the oscillation frequency of the local oscillator 18 based on the processing result. The central processing unit 30 outputs the data based on the processing result to the digital modulator 28.

The digital modulator 28 is constituted to be input with the frequency data as the reception channel information for programming a plurality of reception channels, and the digital modulator 28 modulates the oscillation frequency of the local oscillator 18 in accordance with the frequency data as the reception channel information. As the modulation method, for instance, the FSK modulation method may be employed, and the frequency data may be modulated at 1200 bps, 1200 Hz (space 0), 1800 Hz (mark 1).

With the receiver having the foregoing constitution, when the reception frequency of the high frequency amplifier 14 is tuned to 1300 MHz, a radio wave of 1300 MHz is received as the radio wave of the reception channel, and the high frequency signal and local oscillation frequency signal of the received radio wave are mixed with the frequency mixer 16 so as to create an intermediate frequency signal. When this intermediate frequency signal is amplified with the intermediate frequency amplifier 20 and thereafter demodulated with the demodulator 22, after the low frequency signal is amplified with the low frequency amplifier 26, sound is output from the speaker in accordance with the low frequency signal, and the digital data demodulated with the digital signal demodulator 24 is processed with the central processing unit 30. The processing result is displayed on the screen of the display unit 36, and data relating to the processing result is stored in the data storage device 32.

Here, since the local oscillation signal of the local oscillator 18 is modulated with the digital modulator 28 pursuant to the frequency data as the reception channel information, the local oscillation frequency signal modulated with the frequency data among the high frequency signals pursuant to the oscillation operation of the local oscillator 18 will leak as an electromagnetic wave. The level of this leakage electromagnetic wave arising from the leak is weak, and, for example, the electric field density at a point 3 m away from the receiver 10 is 200 μV/m or less. This value satisfies the FCC standard.

Meanwhile, although the level of the leakage electromagnetic wave leaked from the receiver 10 is weak, as a result of disposing another receiver as the communication target in the vicinity of the receiver 10, the leakage electromagnetic wave can be transmitted from the receiver 10 to the other receiver.

In other words, another receiver as the communication target is disposed at a close distance to perform communication with the receiver 10 at a close distance, and, when the reception frequency of the other receiver is set to the local oscillation frequency 919.3 MHz of the receiver 10, the local oscillation frequency signal modulated with the frequency data will leak as the leakage electromagnetic wave from the receiver 10, and this leakage electromagnetic wave will propagate to its periphery, whereby this leakage electromagnetic wave can be received by the other receiver. And, in the other receiver, as a result of demodulating the local oscillation frequency signal superposed on the received leakage electromagnetic wave and processing the demodulated frequency data, the reception channel can be programmed, the programmed frequency data can be stored in the memory, and an arbitrary channel can be selected thereby.

As described above, in the present embodiment, without having to provide a new wireless data transmitter or dedicated transmission circuit, the receiver of the communication target is able to receive the reception channel information by modulating the local oscillation frequency signal of the receiver 10 with the frequency data as the reception channel information, and transmitting the modulated local oscillation frequency signal as the leakage electromagnetic wave to a single or a plurality of receivers of the communication target.

In addition, as the reception channel information, a sound signal may be used as a substitute for the frequency data for performing modulation.

In the foregoing embodiment, although a single signal as the local oscillation frequency signal of the local oscillator 18 was used, it is also possible to use a local oscillator 18 which generates a plurality of local oscillation frequency signals or a frequency mixer 16 which generates a plurality of intermediate frequencies.

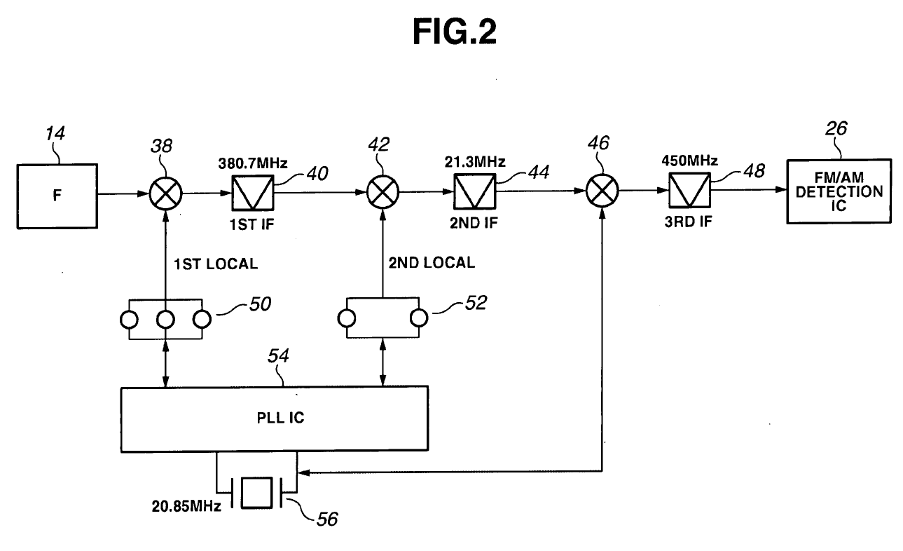

Specifically, as depicted in FIG. 2, it is possible to adopt a constitution where a first frequency mixer 38, a second frequency mixer 42 and a third frequency mixer 46 are provided in substitute for the frequency mixer 16, a first intermediate frequency amplifier 40, a second intermediate frequency amplifier 44 and a third intermediate frequency amplifier 48 are provided in substitute for the intermediate frequency amplifier 20, a first local oscillator 50 and a second local oscillator 52 are provided in substitute for the local oscillator 18, and a frequency setting unit 54 constituted with a phase-locked loop integrated circuit (PLL IC) is provided in substitute for the digital modulator 28 and the central processing unit 30.

The frequency setting unit 54 is constituted to set the oscillation frequency of the first local oscillator 50 and second local oscillator 52 based on the output signal of the reference oscillator 56 which generates a reference signal of a reference frequency of 20.85 MHz, and modulate and output the frequency data as the reception channel information to any one of the local oscillation frequency signals. Here, when the reception frequency band of the high frequency amplifier 14 is allocated to 25.0 to 225.0 MHz, 400.0 to 512.0 MHz, and 806.0 to 1300.0 MHz, in order to make the intermediate frequency of the intermediate frequency signal generated with the first frequency mixer 38 constantly 380.7 MHz, as shown in Table 1 below, the first local oscillation frequency (FL1) to the first local oscillator 50 is sequentially set to 405.7 to 919.3 MHz when the reception frequency changes within the range of 25.0 MHz to 300.0 MHz.

TABLE 1

1ST LOCAL

| F | FL1 | N DATA | |
|---|---|---|---|
| 25.0 | 405.7 | 8114 | (=405.7/0.05) |
| 25.1 | 405.8 | 8116 | (=405.8/0.05) |
| . . . | . . . | . . . | |
| 28.0 | 408.7 | 8174 | (=408.7/0.05) |
| 54.0 | 434.7 | 8694 | (=434.7/0.05) |
| 108.0 | 488.7 | 9774 | (=488.7/0.05) |
| 137.0 | 517.7 | 10354 | (=517.7/0.05) |
| 174.0 | 554.7 | 11094 | (=554.7/0.05) |
| 216.0 | 596.7 | 11934 | (=596.7/0.05) |
| 225.0 | 605.7 | 12114 | (=605.7/0.05) |
| 400.0 | 780.7 | 15614 | (=780.7/0.05) |
| 512.0 | 892.7 | 17854 | (=892.7/0.05) |
| 806.0 | 425.3 | 8506 | (=425.3/0.05) |
| 849.0 | 468.3 | 9366 | (=468.3/0.05) |
| 894.0 | 513.3 | 10266 | (=513.3/0.05) |
| 1240.0 | 859.3 | 17186 | (=859.3/0.05) |
| 1300.0 | 919.3 | 18386 | (=919.3/0.05) |

Further, in the frequency mixer 42 for mixing the intermediate frequency signal output from the first intermediate frequency amplifier 40 and the second local oscillation frequency signal of the second local oscillator 52, a signal of 21.3 MHz is created as the frequency of the intermediate frequency signal. Here, the frequency setting unit 54, as shown in Table 2 below, sets the second local oscillation frequency between 359.4950 and 359.3050 MHz against the second local oscillator 52 in the reception frequency bands where the reception frequency is 25 to 225 MHz, 400 to 512 MHz and 806 to 1300 MHz.

TABLE 2

| | MAGNITUDE OF | | |
|---|---|---|---|
| | FREQUENCY | | |
| | CHANGE LESS | 2ND LOCAL | |
| RANGE | THAN 100 KHz | FL2 | N DATA |
| 25-225 | 0.000 | 359.4000 | 71880 (=359.400/0.005) |
| | 0.005 | 359.3950 | 71879 (=359.395/0.005) |
| | . . . | . . . | . . . |
| | 0.095 | 359.3050 | 71861 (=359.305/0.005) |
| 400-512 | 0.000 | 359.4000 | 71880 (=359.400/0.005) |
| | 0.005 | 359.3950 | 71879 (=359.395/0.005) |
| | . . . | . . . | . . . |
| | 0.095 | 359.3050 | 71861 (=359.305/0.005) |
| 806-1300 | 0.000 | 359.4000 | 71880 (=359.400/0.005) |
| | 0.005 | 359.4050 | 71881 (=359.405/0.005) |
| | . . . | . . . | . . . |
| | 0.095 | 359.4950 | 71899 (=359.495/0.005) |

In Table 1 and Table 2, the step of the local oscillation frequency is shown in a case of 5 kHz.

When the frequency steps of the respective local oscillators 50, 52 are set to 7.5 kHz, the relationship between the first local oscillation frequency and the second local oscillation frequency in the respective reception frequency bands will become the relationship shown in the following Table 3.

TABLE 3

| | | | | MAGNITUDE OF | | |
|---|---|---|---|---|---|---|
| | | | | FREQUENCY | | |
| | 1ST LOCAL | | | CHANGE LESS | 2ND LOCAL | |
| F | FL1 | N DATA | | THAN 75 KHz | FL2 | N DATA |
| 25.0050 | 405.675 | 5409 | (=405.675/0.075) | 0.0000 | 359.3700 | 47916 (=359.3700/0.0075) |
| 25.0800 | 405.750 | 5410 | (=405.750/0.075) | 0.0000 | 359.3700 | 47916 (=359.3700/0.0075) |
| . . . | . . . | . . . | | . . . | . . . | . . . |
| 28.0050 | 408.675 | 5449 | (=408.675/0.075) | 0.0000 | 359.3700 | 47916 (=359.3700/0.0075) |
| 108.0000 | 488.625 | 6515 | (=488.625/0.075) | 0.0450 | 359.3250 | 47910 (=359.4150/0.0075) |
| 137.0025 | 517.650 | 6902 | (=517.650/0.075) | 0.0225 | 359.3475 | 47913 (=359.3475/0.0075) |
| 216.0000 | 596.625 | 7955 | (=596.625/0.075) | 0.0450 | 359.3250 | 47910 (=359.3250/0.0075) |
| 400.0050 | 780.600 | 10408 | (=780.600/0.075) | 0.0300 | 359.2950 | 47906 (=359.2950/0.0075) |
| 806.0025 | 425.400 | 5672 | (=425.400/0.075) | 0.0000 | 359.3025 | 47907 (=359.3025/0.0075) |
| 849.0150 | 468.375 | 6245 | (=468.375/0.075) | 0.0375 | 359.3400 | 47912 (=359.3400/0.0075) |
| 894.0150 | 513.375 | 6845 | (=513.375/0.075) | 0.0375 | 359.3400 | 47912 (=359.3400/0.0075) |
| 1240.0050 | 859.350 | 11458 | (=859.350/0.075) | 0.0525 | 359.3550 | 47914 (=359.3550/0.0075) |
| 1299.9975 | 919.350 | 12258 | (=919.350/0.075) | 0.0450 | 359.3475 | 47913 (=359.3475/0.0075) |

The third frequency mixer 46 mixes the intermediate frequency signal output from the second intermediate frequency amplifier 44 and the reference frequency signal output from the reference oscillator 56, and outputs a signal of 450 kHz as the intermediate frequency. The third intermediate frequency amplifier amplifies the 450 kHz intermediate frequency signal and outputs the amplified signal to the demodulator 26.

In the present embodiment, as a result of modulating the first local oscillation frequency signal or the second local oscillation frequency signal with the frequency data as the reception channel information in the first local oscillator 50 or the second local oscillator 52, and transmitting the modulated local oscillation frequency signal as a leaked radio wave to the receiver of the communication target disposed at a close distance, it is possible to receive the leakage electromagnetic wave with the communication device of the communication target.

In addition, upon providing a function for switching the reception mode to the frequency control device 30, it is possible to adopt a constitution of adding the modes of AM, FM, NFM and WFM, and selecting the designated reception mode in response to the mode switching operation.

Thus, the present invention permits reception channel information to be transmitted from a transmitter having a receiving function to the transmitter of the communication target, without having to provide a new wireless data transmitter or dedicated transmission circuit.

While the invention has been described herein with reference to illustrative features and embodiments, other variations, modifications and alternative embodiments of the invention will readily suggest themselves to those of ordinary skill in the art based on the disclosure herein, and therefore are to be regarded as being within the spirit and scope of the invention.

What is claimed is:

1. A leakage electromagnetic wave communication method, comprising the steps of:
setting the reception frequency of one communication device among a plurality of communication devices to a designated frequency;
setting the reception frequency of the other communication device to a local oscillation frequency of said one communication device;
modulating the local oscillation frequency signal of said one communication device in accordance with reception channel information; and
transmitting the local frequency signal modulated with said reception channel information as a leakage electromagnetic wave from said one communication device to the other communication device.

2. A leakage electromagnetic wave communication method, comprising the steps of:
setting the reception frequency of one communication device among a plurality of communication devices to a designated frequency;
setting the reception frequency of the other communication device to a local oscillation frequency of said one communication device;
modulating the local oscillation frequency signal of said one communication device in accordance with a reception channel sound signal; and
transmitting the local frequency signal modulated with said reception channel sound signal as a leakage electromagnetic wave from said one communication device to the other communication device.

3. A leakage electromagnetic wave communication device, comprising:
high frequency amplifying means for amplifying a high frequency signal received with an antenna;
frequency oscillating means for oscillating said high frequency signal and a signal having a fixed frequency difference;
frequency mixing means for mixing the output signal of said high frequency amplifying means and the output signal of said frequency oscillating means and outputting an intermediate frequency signal;
processing means for setting an oscillation frequency of said frequency oscillating means; and
modulating means for modulating the oscillation signal of said frequency oscillating means in accordance with reception channel information.

4. A leakage electromagnetic wave communication device, comprising:
high frequency amplifying means for amplifying a high frequency signal received with an antenna;
frequency oscillating means for oscillating said high frequency signal and a signal having a fixed frequency difference;
frequency mixing means for mixing the output signal of said high frequency amplifying means and the output signal of said frequency oscillating means and outputting an intermediate frequency signal;
intermediate frequency amplifying means for amplifying said intermediate frequency signal;
demodulating means for demodulating the output signal of said intermediate frequency amplifying means and outputting data;
processing means for processing data demodulated with said demodulating means and setting an oscillation frequency of said frequency oscillating means based on the processing result; and
modulating means for modulating the oscillation signal of said frequency oscillating means based on the processing result of said processing means and in accordance with reception channel information.

5. A leakage electromagnetic wave communication device, comprising:
high frequency amplifying means for receiving a radio wave belonging to one frequency band among a plurality of frequency bands and amplifying the high frequency signal from the received radio wave;
local frequency oscillating means for oscillating said high frequency signal and a local frequency signal having a fixed frequency difference;
frequency mixing means for mixing the output signal of said high frequency amplifying means and the output signal of said local frequency oscillating means and outputting an intermediate frequency signal;
intermediate frequency amplifying means for amplifying said intermediate frequency signal;
demodulating means for demodulating the output signal of said intermediate frequency amplifying means and outputting data;
processing means for processing data demodulated with said demodulating means and setting an oscillation frequency of said local frequency oscillating means based on the processing result; and
modulating means for modulating the oscillation signal of said local frequency oscillating means based on the processing result of said processing means and in accordance with a reception channel sound signal.

6. A leakage electromagnetic wave communication device, comprising:
high frequency amplifying means for amplifying a high frequency signal received with an antenna;
plurality of frequency oscillating means for oscillating said high frequency signal and a signal having a fixed frequency difference;
plurality of frequency mixing means for mixing the output signal of said high frequency amplifying means and the output signal of any one of said frequency oscillating means and outputting an intermediate frequency signal;
processing means for setting an oscillation frequency of each of said frequency oscillating means; and
modulating means for modulating the oscillation signal of any one of said frequency oscillating means in accordance with reception channel information.

7. A leakage electromagnetic wave communication device, comprising:
high frequency amplifying means for amplifying a high frequency signal received with an antenna;
plurality of frequency oscillating means for oscillating said high frequency signal and a signal having a fixed frequency difference;
plurality of frequency mixing means for mixing the output signal of said high frequency amplifying means and the output signal of any one of said frequency oscillating means and outputting an intermediate frequency signal;
plurality of intermediate frequency amplifying means for respectively amplifying the intermediate frequency signals output from each of said frequency mixing means;
demodulating means for demodulating the back-end output signal among said plurality of intermediate frequency amplifying means and outputting data;
processing means for processing data demodulated with said demodulating means and setting an oscillation frequency of each of said frequency oscillating means based on the processing result; and
modulating means for modulating the oscillation signal of any one of said frequency oscillating means based on the processing result of said processing means and in accordance with reception channel information.

8. A leakage electromagnetic wave communication device, comprising:
high frequency amplifying means for receiving a radio wave belonging to one frequency band among a plurality of frequency bands and amplifying the high frequency signal from the received radio wave;
plurality of local frequency oscillating means for oscillating said high frequency signal and a local frequency signal having a fixed frequency difference;
plurality of frequency mixing means for mixing the output signal of said high frequency amplifying means and the output signal of any one of said frequency oscillating means and outputting an intermediate frequency signal;
plurality of intermediate frequency amplifying means for amplifying any one of said intermediate frequency signals;
demodulating means for demodulating the back-end output signal among said plurality of intermediate frequency amplifying means and outputting data;
processing means for processing data demodulated with said demodulating means and setting an oscillation frequency of each of said local frequency oscillating means based on the processing result; and
modulating means for modulating the oscillation signal of any one of said local frequency oscillating means based on the processing result of said processing means and in accordance with reception channel information.

9. A leakage electromagnetic wave communication device, comprising:
high frequency amplifying means for receiving a radio wave belonging to one frequency band among a plurality of frequency bands and amplifying the high frequency signal from the received radio wave;
plurality of local frequency oscillating means for oscillating said high frequency signal and a local frequency signal having a fixed frequency difference;
plurality of frequency mixing means for mixing the output signal of said high frequency amplifying means and the output signal of any one of said frequency oscillating means and outputting an intermediate frequency signal;
plurality of intermediate frequency amplifying means for amplifying any one of said intermediate frequency signals;
demodulating means for demodulating the back-end output signal among said plurality of intermediate frequency amplifying means and outputting data;
processing means for processing data demodulated with said demodulating means and setting an oscillation frequency of each of said local frequency oscillating means based on the processing result; and
modulating means for modulating the oscillation signal of any one of said local frequency oscillating means based on the processing result of said processing means and in accordance with a reception channel sound signal.
